(19) United States
(12) Patent Application Publication
(10) Pub. No.: US 2026/0025773 A1
(43) Pub. Date: Jan. 22, 2026

(54) Method for High-Precision Time Synchronization Across Multiport in 5G User Plane Function

(71) Applicant: HONG KONG APPLIED SCIENCE AND TECHNOLOGY RESEARCH INSTITUTE COMPANY LIMITED, Shatin (HK)

(72) Inventors: Liang XIA, Guangdong Province (CN); Jianjun ZHANG, Guangdong (CN); Yau Yau Yolanda TSANG, North Point (HK); Min LIU, Sha Tin (HK); Wei LI, Sha Tin (HK)

(73) Assignee: HONG KONG APPLIED SCIENCE AND TECHNOLOGY RESEARCH INSTITUTE COMPANY LIMITED, Shatin (HK)

(21) Appl. No.: 19/316,294

(22) Filed: Sep. 2, 2025

Related U.S. Application Data
(63) Continuation-in-part of application No. 18/110,594, filed on Feb. 16, 2023, now Pat. No. 12,438,633.

(51) Int. Cl. H04W 56/00

(52) U.S. Cl. CPC H04W 56/0045; H04W 56/0055

(57) ABSTRACT

Described is a method of synchronizing a Network-Side Time-Sensitive Networking (TSN) Translator (NW-TT) module inside a User Plane Function (UPF) of a communication network with a Grandmaster (GM) in a 5G Time Domain of the communication network. The method includes adjusting a clock frequency of the N3 interface to synchronize the time between the N3 interface and the GM. The method includes generating one or more pulses at a pin of the N3 interface. The method includes detecting the one or more pulses at a pin of the NW-TT module. The method includes determining a time offset value (Offset_{NW-TT}) between the N3 interface and the NW-TT module. The method includes adjusting a time or a clock frequency of the NW-TT module using the determined time offset value (Offset_{NW-TT}) to synchronize the time between the NW-TT module and the GM.

### CROSS-REFERENCE TO RELATED APPLICATIONS

This application is a continuation-in-part of U.S. patent application Ser. No. 18/110,594, filed on Feb. 16, 2023, published as US2024/0283555A1, the entire contents of which are hereby incorporated by reference herein.

### TECHNICAL FIELD

This disclosure relates to a method for high-precision time synchronization with Grandmaster (GM) for User Plane Function (UPF). This disclosure is particularly useful for multiport high-precision time synchronization with Fifth-generation (5G) GM in UPF of 5G Time Domain.

### BACKGROUND

5G wireless communications and Time-Sensitive Networking (TSN) are key technologies for, for example, industrial communications such as 5G for wireless connectivity and TSN for wired connectivity. In addition to enhanced mobile broadband (eMBB), 5G supports communications with unprecedented reliability and very low latency, as well as massive Internet of Things (IoT) connectivity.

TSN comprises a collection of Ethernet standards introduced by the Institute of Electrical and Electronic Engineers (IEEE) 802.1 group, defining mechanisms for deterministic communication over wired Ethernet links enabling guaranteed packet transport with bounded latency, low packet delay variation, and extremely low packet loss. Both technologies have been designed to provide converged communication for a wide range of services on a common network infrastructure. Significant benefits can be achieved by enabling TSN and 5G to work together.

For a seamless integration between a 5G system (5GS) and a TSN system, it was proposed by the 3rd Generation Partnership Project (3GPP) that the two systems interoperate in a transparent manner to minimize impact on other TSN entities. Therefore, the 5G system acts as one or more virtual TSN bridges of the TSN network. This virtual bridge model defines several gateways between the TSN and the 5G system including a network-side TSN translator (NW-TT) on the user plane function (UPF) side.

The Precision Time Protocol (PTP) or Generalized PTP (gPTP) is a computer networking protocol for synchronizing network elements' clocks. It is an important part of 5G mobile networks which require accurate time sources. The PTP or gPTP is a protocol used to synchronize clocks throughout the communication network, achieving clock accuracy in the sub-microsecond range, making it the perfect choice where strict time synchronization requirements must be met.

A PTP or gPTP system is formed by a clock source, a Grandmaster (GM), that transmits synchronization information toward multiple clock targets (slave devices). IEEE 802.1AS comprises the IEEE standard for time synchronization of time-sensitive applications in local and metropolitan area networks using gPTP. GM/Slave refers to the timing source in the network being generated by a gPTP GM. The Slave clock utilizes an offset to adjust its time to agree with the Master clock. Other than offset adjustment, the clock frequency of the Slave should also be synchronized with the gPTP GM. Without frequency synchronization, the time of the Slave might still run faster or slower than the GM.

The 5G network supports time synchronization as defined by IEEE 802.1AS across 5G-based logical TSN bridges with Ethernet PDU (Packet Data Unit) session type in the TSN Time Domain. The 5G-based logical TSN bridge needs to calculate the residence time of the 5G network. The 5G network provides an internal system clock for 5G internal synchronization where the base station (gNB), the NW-TT at the UPF side and the device side TST translator (DS-TT) at the User Equipment (UE) side should all be synchronized in the 5G Time Domain with the 5G GM for residence time calculation.

US20220361129A1 provides a time synchronization method, an access network device, a communication apparatus, a computer storage medium, and a communication system. The method includes: A first access network device obtains first indication information, where the first indication information is used to indicate that a first terminal has a requirement for receiving or sending an uplink time synchronization message, and/or the indication information is used to indicate a precision requirement for time synchronization between the first terminal and a wireless network. The first access network device performs time synchronization on the first terminal based on the first indication information.

US20220216932A1 provides systems and methods related to conveying Time Sensitive Networking (TSN) synchronization information within a cellular communication system (e.g., a Fifth Generation System (5GS)) are disclosed. In one embodiment, a method performed by a User Equipment (UE) in a cellular communications system or a TSN Translator (TT) associated with the UE comprises receiving, from a TSN end station, a Precision Time Protocol (PTP) or generalized PTP (gPTP) announce message comprising information that identifies one or more clock domains for which the TSN end station desires to receive PTP or gPTP messages. The method further comprises sending, to a core network node in the cellular communications system, cither: (a) the information that identifies the one or more clock domains extracted from the PTP or gPTP announce message or (b) the PTP or gPTP announce message. Using this information, UE specific PTP or gPTP message filtering may be applied.

The parent application U.S. Ser. No. 18/110,594 (US20240283555A1) proposed a software-based method, where the Central Processing Unit (CPU) directly reads clock times from N3 and NW-TT interfaces and calculate the offset between them.

An object is to further mitigate or obviate to some degree one or more problems associated with known methods of supporting high precision time synchronization of TSN end stations over the communications network.

### SUMMARY

This disclosure focuses on time synchronization within the UPF of 5G Time Domain. This disclosure proposes an innovative hardware-software co-design architecture which specifically calculates the time offset between N3 and NW-TT interfaces through for example General-Purpose Input/Output (GPIO)-based Pulse Per Second (PPS) signal triggering and state machine control, achieving sub-100 ns synchronization accuracy.

In a first aspect, this disclosure provides a method of synchronizing a Network-Side Time-Sensitive Networking (TSN) Translator (NW-TT) module inside a User Plane Function (UPF) of a communication network with a Grandmaster (GM) in a 5G Time Domain of the communication network. The method includes receiving one or more Precision Time Protocol (PTP) or Generalized Precision Time Protocol (gPTP) messages on an N3 interface of the UPF. The method includes determining a first time offset value (Offset_{N3}) between the GM and the N3 interface based on information received in the one or more PTP or gPTP messages. The method includes adjusting a time or a clock frequency of the N3 interface using the determined first time offset value (Offset_{N3}) to synchronize the time between the N3 interface and the GM. The method includes generating one or more pulses at a pin of the N3 interface. The method includes detecting the one or more pulses at a pin of the NW-TT module. The method includes determining a second time offset value (Offset_{NW-TT}) between the N3 interface and the NW-TT module according to a time of generating one pulse of the one or more pulses (T′_{N3}) and a time of detecting the pulse (T_{NW-TT}). The method includes adjusting a time or a clock frequency of the NW-TT module using the determined second time offset value (Offset_{NW-TT}) to synchronize the time between the NW-TT module and the GM.

In a second aspect, this disclosure provides a Data Plane Clock Servo module in a User Plane Function (UPF) module for synchronizing a Network-Side Time-Sensitive Networking (TSN) Translator (NW-TT) module inside the UPF of a communication network with a Grandmaster (GM) in a Time Domain of the communication network. The Data Plane Clock Servo module includes a protocol module, configured to receive one or more Precision Time Protocol (PTP) or Generalized Precision Time Protocol (gPTP) messages on an N3 interface of the UPF; and determine a first time offset value (Offset_{N3}) between the GM and the N3 interface based on information received in the one or more PTP or gPTP messages. The Data Plane Clock Servo module includes a pulse handler module, configured to generate one or more pulses at a pin of the N3 interface; detect the one or more pulses at a pin of the NW-TT module; and determine a second time offset value (Offset_{NW-TT}) between the N3 interface and the NW-TT module according to a time of generating one pulse of the one or more pulses (T′_{N3}) and a time of detecting the pulse (T_{NW-TT}). The Data Plane Clock Servo module includes a synchronization adjuster module, configured to adjust a time of the N3 interface using the determined first time offset value (Offset_{N3}) or adjust a time of the NW-TT module using the determined second time offset value (Offset_{NW-TT}). The Data Plane Clock Servo module includes a clock frequency adjuster module, configured to adjust a clock frequency of the N3 interface using the determined first time offset value (Offset_{N3}) or adjust a clock frequency of the NW-TT module using the determined second time offset value (Offset_{NW-TT}).

In a third aspect, this disclosure provides a non-transitory computer-readable medium storing machine-readable instructions, wherein, when the machine-readable instructions are executed by a processor, they configure the processor to implement the method of the first aspect of this disclosure.

The summary of the invention does not necessarily disclose all the features essential for defining the invention; the invention may reside in a sub-combination of the disclosed features.

The forgoing has outlined fairly broadly the features of the present invention in order that the detailed description of the invention which follows may be better understood. Additional features and advantages of the invention will be described hereinafter which form the subject of the claims of the invention. It will be appreciated by those skilled in the art that the conception and specific embodiment disclosed may be readily utilized as a basis for modifying or designing other structures for carrying out the same purposes of the invention.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 provides a schematic diagram illustrating the residence time;

FIG. 2 provides a block schematic diagram illustrating the TSN Time Domain and the 5G Time Domain in a known IEEE 802.1AS compliant TSN Network;

FIG. 3 is a block schematic diagram illustrating in more detail the UPF in an IEEE 802.1AS compliant TSN Network;

FIG. 4 is a functional block schematic diagram shows the 5G Data Plane Clock Servo module in accordance with the disclosure;

FIG. 5 is a block schematic diagram outlining the steps of the method in accordance with the disclosure;

FIG. 6 is a timing diagram showing transmission of time synchronization information for three adjacent time-aware systems in a TSN Network implementing the method in accordance with the disclosure;

FIG. 7 is a functional block schematic diagram of a clock frequency adjuster function for the 5G Data Plane Clock Servo module in accordance with the disclosure;

FIG. 8 is a schematic diagram shows the configuration for generating and receiving a PPS signal in accordance with the disclosure.

FIG. 9 is a flowchart of the handling of a PPS handler function for the 5G Data Plane Clock Servo module in accordance with the disclosure;

FIG. 10 is a flowchart of the handling of a port synchronization adjuster function for the 5G Data Plane Clock Servo module in accordance with the disclosure; and

FIG. 11 is a chart showing the advantage of the embodiments of the disclosure.

### DETAILED DESCRIPTION OF EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the Figures, may be implemented in various forms of hardware, software or combinations thereof. These elements may be implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

References to 5G radio equipment in the following description do not exclude the application of the methods described herein to radio equipment of compatible mobile communications systems.

The following description describes implementation of the present invention in a 5G communications network by way of example, but without limitation to implementation of the invention in suitable communications networks.

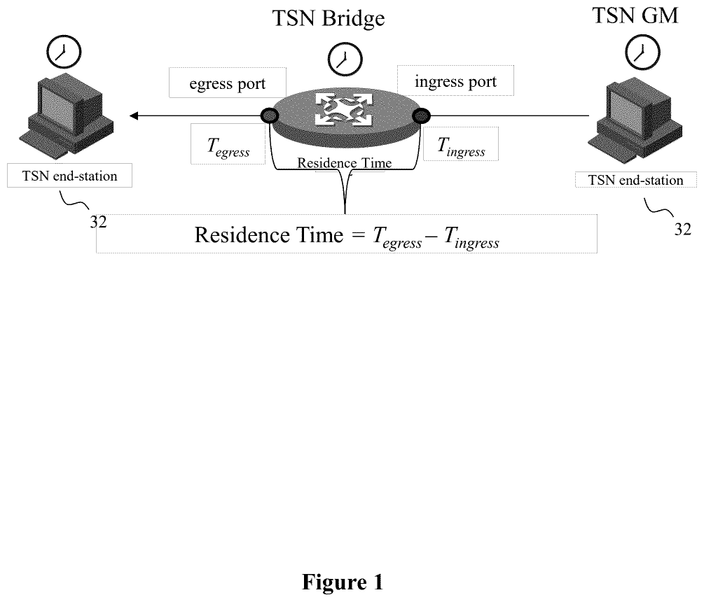

FIG. 1 provides a schematic diagram illustrating the residence time. “Residence Time” is the time between the sync message received at the TSN bridge ingress port and transmitted at the TSN bridge egress port. This time is a part of the link delay between TSN end-stations 32. The end-stations use IEEE 802.1AS for time synchronization across TSN bridge. In the 802.11AS protocol, the TSN bridge put the “Residence Time” into the correction field of PTP packet, thereby achieving synchronization across the entire network. The accuracy of the “Residence Time” will determine the effectiveness of clock synchronization. In the 802.11AS protocol, the Bridge is responsible for progressively accumulating the transmission delay and dwell time of the intermediate path into the correction field, thereby achieving synchronization across the entire network. The accuracy of the dwell time will determine the effectiveness of clock synchronization.

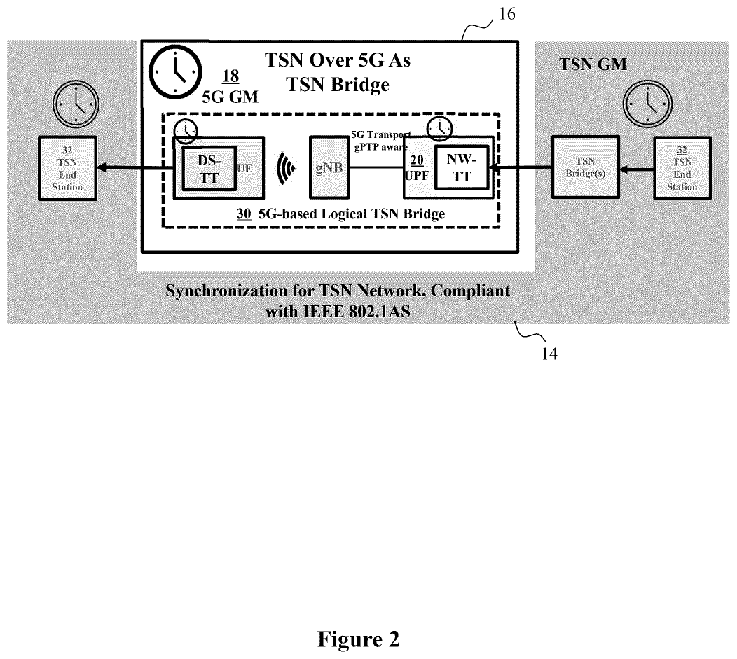

FIG. 2 provides a block schematic diagram illustrating the TSN Time Domain 14 and the 5G Time Domain 16 in a known IEEE 802.1AS compliant TSN Network.

The TSN Time Domain 14 for the 5G network supports time synchronization (as defined by IEEE 802.1AS) across 5G-based logical TSN bridge(s) 30 with Ethernet Packet Data Unit (PDU) session type in the TSN Time Domain 14. The 5G-based logical TSN bridge(s) 30 needs to calculate the residence time of the 5G network.

The 5G Time Domain 16 for the 5G network provides an internal system clock for 5G internal synchronization where the gNB, the NW-TT at UPF side 20 and the DS-TT at UE side should all be synchronized in the 5G Time Domain with a 5G GM 18 for residence time calculation.

The disclosure focuses on time synchronization in the 5G Time Domain 16 as will be described more fully hereinafter.

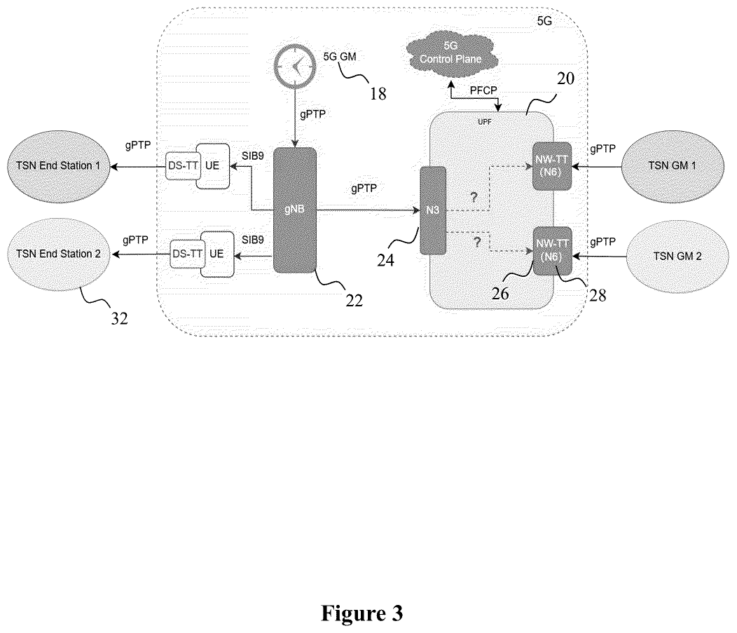

FIG. 3 provides a block schematic diagram illustrating in more detail the UPF 20 in the IEEE 802.1AS compliant TSN Network of FIG. 2.

Referring to FIG. 3, the 5G GM 18, the gNB 22 and the N3 interface 24 of the UPF 20 synchronize time through the gPTP protocol in accordance with the 3GPP specifications. However, the method by which the NW-TT module 26 at the N6 interface 28 on the UPF 20 synchronizes its time with the UPF N3 interface 24 is outside the scope of the 3GPP specifications. In the 3GPP specifications, the NW-TT module 26 is based on the N6 interface 28 of the UPF 20. In most cases, the N3 interface 24 and the N6 interface-based NW-TT module 26 on the same UPF 20 use different network interfaces. However, different network interfaces commonly use different sources of oscillator and thus typically have different hardware clock sources which may vary in their respective timings. Without time synchronization of the NW-TT module 26 in the UPF 20 with the 5G GM 18 in the 5G Time Domain 16, the residence time calculation of any 5G-based logical TSN bridge 30 (FIG. 2) will be incorrect, which will cause incorrect time synchronization of TSN end stations 32 over the 5G communications network.

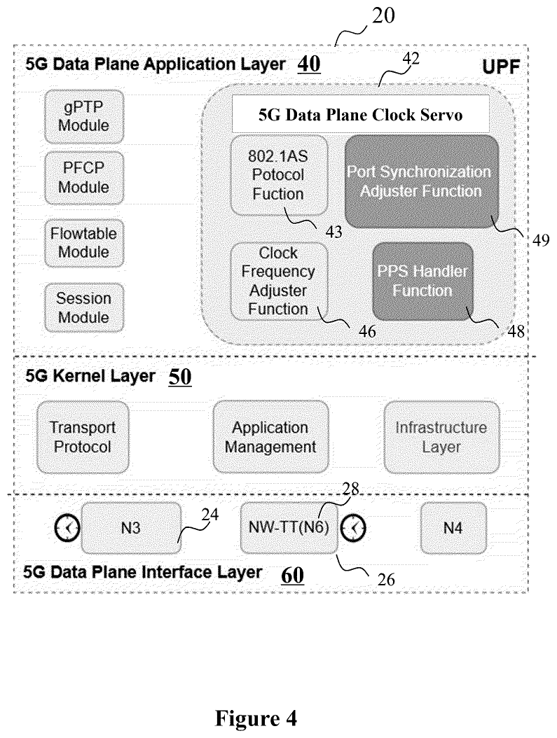

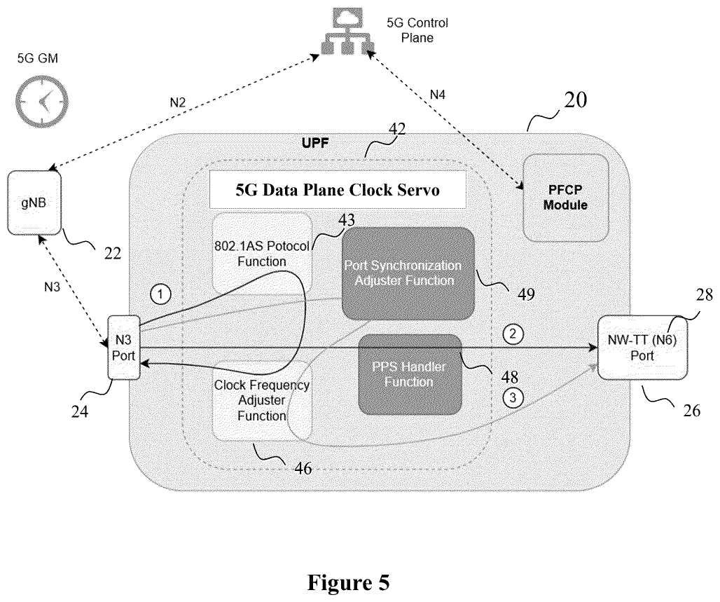

The present disclosure addresses the problem of how to enable the NW-TT module 26 in the UPF 20 to track the 5G GM 18 precisely with at least time synchronization and preferably also frequency synchronization. To this end, the present disclosure provides, as illustrated by FIG. 5, a 5G Data Plane Clock Servo module 42 in the UPF 20 as illustrated in FIG. 4.

FIG. 4 is a functional block schematic diagram shows the 5G Data Plane Clock Servo module 42 in accordance with the disclosure. As shown in FIG. 4, the UPF may include multiple layers, for example 5G data plane application layer 40, 5G kernel layer 50, and 5G data plane interface layer 60. The 5G data plane application layer 40 may comprise a gPTP module, a Packet Forwarding Control Protocol (PFCP) module, a flowtable module, and a session module. In addition, the 5G data plane application layer 40 may comprise the 5G Data Plane Clock Servo module 42. The 5G kernel layer 50 may comprise a transport protocol, an application management, and an infrastructure layer. The 5G data plane interface layer 60 may comprise the N3 interface 24, the N6 interface 28 at which the NW-TT module 26 is based, and a N4 interface.

The User Plane Function (UPF) with TSN (Time-Sensitive Networking) enabled includes the 5G Data Plane Clock Servo module 42, which is responsible for handling key TSN protocols and functionalities related to IEEE 802.1AS, 802.1Qbv, 802.1Qbu, and NW-TT (Network Time Translator). The 5G Data Plane Clock Servo module 42 includes but is not limited to the time synchronization aspects, such as an IEEE 802.1AS protocol function 43, a clock frequency adjuster function 46, a port synchronization adjuster function 49, and a PPS handler function 48.

The IEEE 802.1AS protocol function 43 enables clock synchronization of the N3 interface 24 within the 5G domain 18 and seamlessly connects to the TSN domain using PTP packet penetration technology, as specified in IEEE 802.1AS standard.

The clock frequency adjuster function 46 dynamically calibrates clock frequency via a Proportional-Integral (PI) control algorithm, compensating for crystal oscillator drift and environmental interference.

The port synchronization adjuster function 49 maintains a port state machine designed to continuously monitor the synchronization status of the port and handle any anomalies that may arise.

The PPS handler function 48 transmits and receives high-precision PPS signals via programmable pins of an Ethernet chip, providing a unified synchronization reference for multi-port.

FIG. 5 is a block schematic diagram outlining the steps of the method in accordance with the disclosure. The N6 interface 28, at which the NW-TT module 26 is based, in User Plane Function (UPF) needs to synchronize its time with 5G GM in the 5G Time Domain. The FIG. 5 shows the procedures of time synchronization of NW-TT module with 5G GM in 5G Time Domain.

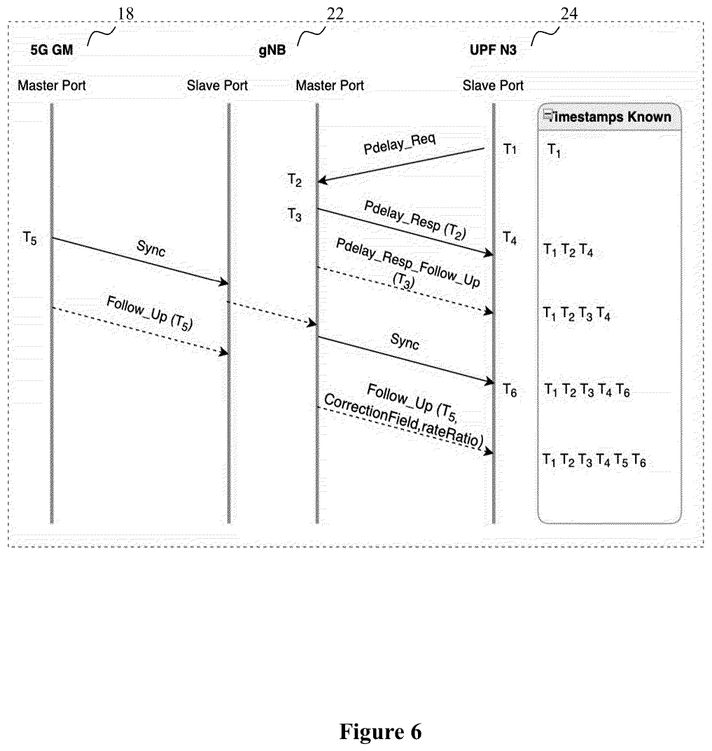

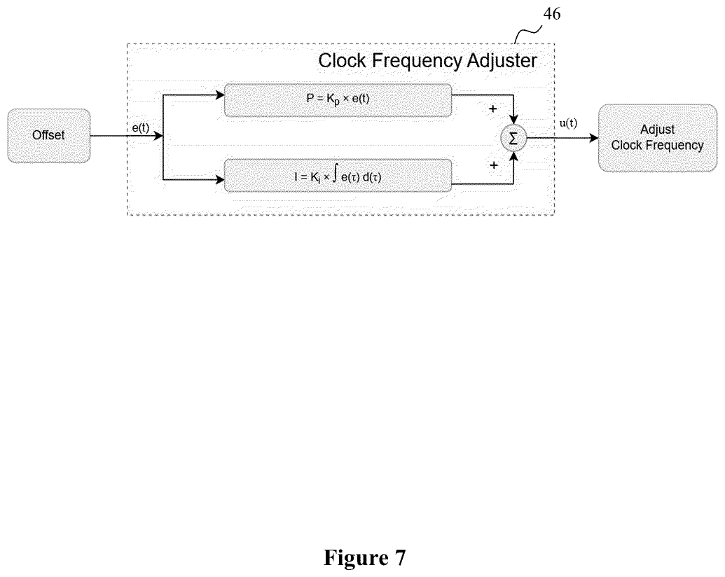

Step 1: The IEEE 802.1AS protocol function 43 obtains the 5G GM clock via the underlying gPTP-Compatible transport network through the N3 interface, then calculates the Offset_{N3} between 5G GM and UPF N3. Offset_{N3} is used as input for the clock frequency adjuster function 46 to adjust the UPF N3 clock frequency. More details will be described by referring FIG. 6 and FIG. 7.

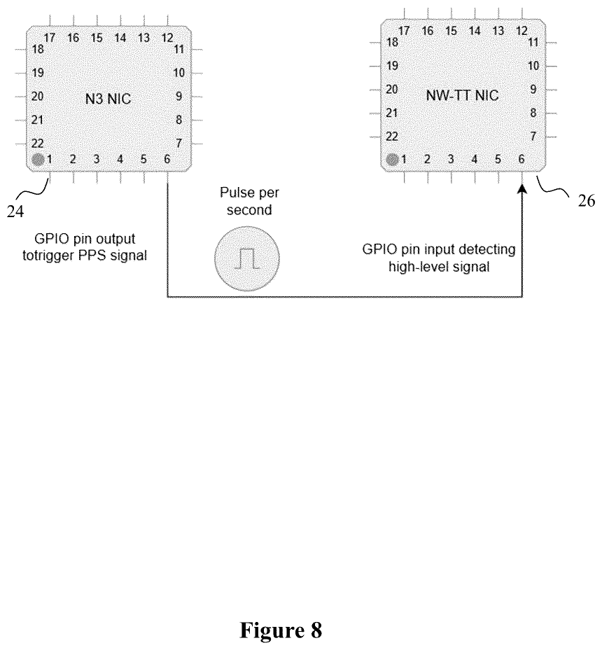

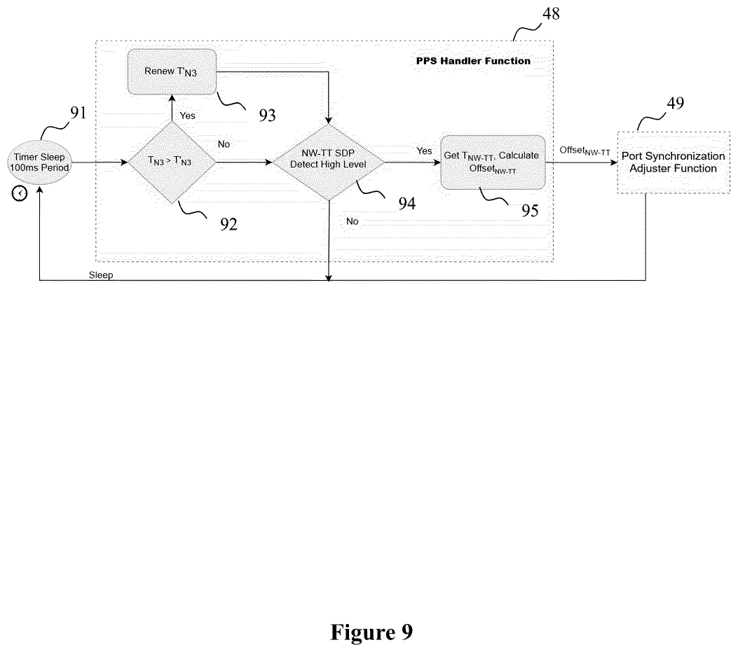

Step 2: The PPS handler function 48 configures the N3 interface to emit a high-level pulse (such as PPS signal) at every full second via a pin (such as an GPIO pin). The N6 interface 28, at which the NW-TT module 26 is based, acts as the pulse capturer, detecting and recording the exact time step upon detecting the rising edge of the pulse, then calculates the Offset_{NW-TT}between UPF N3 timestamp with NW-TT timestamp. More details will be described by referring FIG. 8 and FIG. 9.

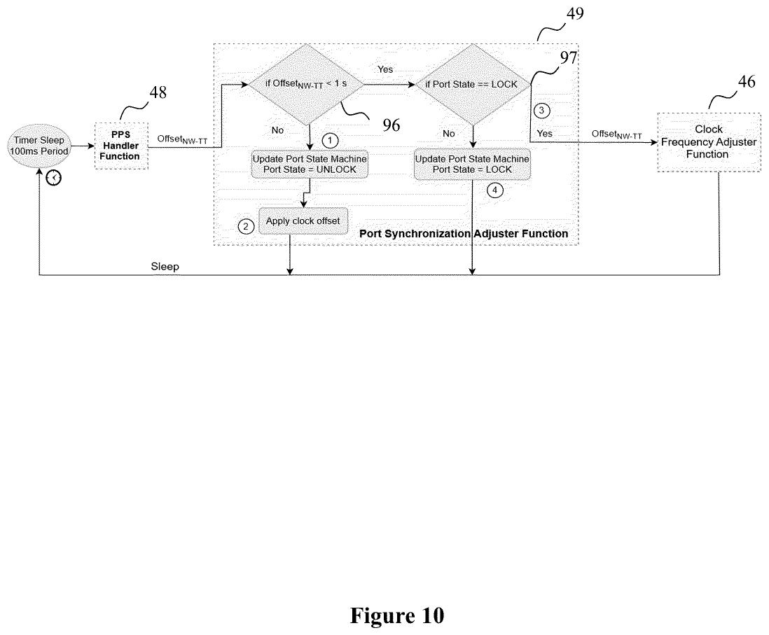

Step 3: The port synchronization adjuster function 49 maintains a state machine to make the Offset_{NW-TT} stable and collects the Offset_{NW-TT} from Step 2 and inputs it into the clock frequency adjuster function 46 to obtain the NW-TT clock frequency adjustment value. More details will be described by referring FIG. 10 and FIG. 7.

FIG. 6 is a timing diagram showing transmission of time synchronization information for three adjacent time-aware systems in a TSN Network implementing the method in accordance with the disclosure.

The one or more PTP or gPTP messages received by the UPF N3 interface 24 of the UPF 20 contain synchronization information in peer-to-peer mode or end-to-end mode. The method comprises the steps of storing a first time T₁ relating to sending a PTP or gPTP “Pdelay_Req” message, extracting a second time T₂ from a PTP or gPTP “Pdelay_Resp” message, extracting a third time T₃ from a PTP or gPTP “Pdelay_Resp_Follow_Up” message, storing a fourth time T₄ relating to receiving a PTP or gPTP “Pdelay_Resp” message, and then determining a UPF N3 interface delay (Delay_{N3}) from the formula:

$${Delay}_{N 3} = [ ( {T}_{2} - {T}_{1} ) + ( {T}_{4} - {T}_{3} ) ] / 2.$$

The first time offset value (Offset_{N3}) between the 5G GM 18 and the UPF N3 interface 24 is derived from the UPF N3 interface delay (Delay_{N3}). To obtain the first time offset value (Offset_{N3}) between the 5G GM 18 and the UPF N3 interface 24, the method includes the steps of extracting a fifth time T₅ and a Correction Field (CF) elapsed time value from a PTP or gPTP “Follow_Up” message, storing a sixth time T₆ relating to receiving a PTP or gPTP “Sync message”, and then determining the first time offset value (Offset_{N3}) between the 5G GM and the UPF N3 interface from the formula:

$${Offset}_{N 3} = ( {T}_{6} - {T}_{5} ) - {Delay}_{N 3} - CF elapsed time value .$$

The CF carries the time elapsed in the time-aware systems and on the links on the path between the 5G GM 18 and the time-aware system preceding the last hop. In this case it is the transmit time from a 5G GM master port to a gNB master port.

FIG. 7 is a functional block schematic diagram of a clock frequency adjuster function 46 for the 5G Data Plane Clock Servo module in accordance with the disclosure. The clock frequency adjuster function 46 provides a 5G Data Plane PI Controller, the proportional (P) term tracks and corrects the direct input, which is the time difference between the two clocks, the integral (I) term tracks and corrects the steady-state error, which is the frequency difference between the two clocks, and the Kₚ and Kᵢ tuning parameters may be either static or dynamically adjusted according to deployment scenarios such that:

$$u ( t ) = {K}_{p} e ( t ) + {K}_{i} {\int }_{0}^{t} e ( τ ) d τ .$$

where Kₚ is the proportional gain, a tuning parameter;
Kᵢ is the integral gain, a tuning parameter;
e(t) is the clock error (offset) between the 5G GM 18 and the UPF N3 interface 24 or the and NW-TT module 26;
t is the time or instantaneous time (current time t); and
τ is the variable of integration (takes on values from time 0 to the current time t).

The method also includes using 5G Data Plane clock frequency adjuster 46 to receive the fractional tick-rate adjustment u(t) value for the UPF N3 interface 24 or the NW-TT module 26 and adjust the respective clock frequency accordingly.

FIG. 8 is a schematic diagram shows the configuration for generating and receiving a PPS signal in accordance with the disclosure. The configuration may support NW-TT multi-ports time synchronization with N3 port.

GPIO pins are programmable hardware interfaces that allow a single physical pin to be dynamically reconfigured via software for different functions, such as input, output, or peripheral control. By combining hardware-timed operations with software flexibility, these pins can achieve high precision, reaching sub-microsecond accuracy. As a result, the PPS can be generated or triggered via GPIO with precisely controlled timing.

In step 2 of the FIG. 5, the configuration for generating and receiving a PPS signal as shown in FIG. 8 may be used to achieve clock synchronization between the N3 port and NW-TT port in UPF 20. As shown in FIG. 8, the GPIO pin of the N3 Network Interface Card (NIC) of N3 interface 24 may be interconnected with the GPIO pin of the NW-TT Network Interface Card (NIC) of N6 interface 28. In a further example, GPIO pins across all NIC chips in the UPF may be interconnected.

The PPS handler function 48 may configure the N3 interface 24 to generate one or more pulses at a pin of the N3 interface; and configure the N6 interface 28 to detect the one or more pulses at a pin of the NW-TT module. Then, the PPS handler function 48 may determine a second time offset value (Offset_{NW-TT}) between the N3 interface and the NW-TT module according to a time of generating one pulse of the one or more pulses (T′_{N3}) and a time of detecting the pulse (T_{NW-TT}).

The PPS handler function 48 may configure the PPS pulse width as 110 ms to allow the NW-TT module to detect high pulse signal(s) during the 100 ms wake-up cycle, enabling the calculation of the Offset_{NW-TT}. In addition, the PPS handler function 48 may dynamically reconfigure the pulse width of the PPS signal via software based on network latency measurements, wherein the PPS pulse width is adjustable within a range of 100 ms to 500 ms to accommodate varying detection capabilities of connected NW-TT modules. The wake-up cycle should adjustable according to the PPS width and be shorter and closer to PPS pulse width to ensure that there is only one detection of a high PPS pulse within 1 second.

FIG. 9 is a flowchart of the handling of a PPS handler function 48 for the 5G Data Plane Clock Servo module in accordance with the disclosure.

Firstly, at step 91, a 100 ms periodic timer is set. The T′_{N3} is initialize as T′_{N3}=0. The N3 port GPIO pin is configured to output PPS signal at precise time T′_{N3}.

Then, at step 92, upon waking up of the timer, the PPS handler function 48 may check whether T_{N3} (the current N3 clock time) is greater than T′_{N3}, if so, at step 93, the PPS handler function 48 may reset T′_{N3} to next full-second, i.e., T′_{N3}=└T_{N3}┘+1, the └ ┘ is a floor operator, to renew GPIO pin triggering PPS signal at T′_{N3} next time. If not, the flowchart proceeds to the next step.

The NW-TT port GPIO pin is configured as high-precision input. Then, at step 94, it is determined that whether a high-level signal is detected. Upon detecting a high-level signal at step 94, the GPIO pin is triggered to capture the NW-TT port clock time T_{NW-TT}. If there is a high-level PPS signal in this wake-up time, go to next step 95. If not, keep on detecting, i.e., return to step 91.

Then, at step 95, the PPS handler function 48 may calculate Offset_{NW-IT}, according to:

$${Offset}_{NW - TT} = {T}_{NW - TT} - {T}_{N 3}^{′} .$$

The calculated Offset_{NW-TT} is sent to the port synchronization adjuster function 49 for time or frequency adjustment of the NW-TT port clock.

By utilizing hardware-software co-design method to calculate the Offset_{NW-TT}, the offset error introduced by hardware access latency, bus contention, cache effects, and user/kernel space switching overhead, etc. can be eliminated, allowing the software to focus more on handling other tasks.

FIG. 10 is a flowchart of the handling of a port synchronization adjuster function 49 for the 5G Data Plane Clock Servo module in accordance with the disclosure. In step 3 of FIG. 5, the port synchronization adjuster function 49 keeps the Port State Machine looping and chooses the best clock adjustment based on the state.

As shown in FIG. 9, in step 2 of the FIG. 5, the PPS handler function 48 may calculate the second time offset value (Offset_{NW-TT}) between the N3 interface and the NW-TT module and send it to the port synchronization adjuster function 49 for time or frequency adjustment of the NW-TT port clock. Then, as shown in FIG. 10, the port synchronization adjuster function 49 may adjust time or frequency adjustment of the NW-TT port clock accordingly, as the details for step 3 of FIG. 5.

As shown in FIG. 10, at step 96, it is determined that whether the Offset_{NW-TT} from the PPS Handler Function is less than 1 second. If not, i.e., when the Offset_{NW-TT} from the PPS handler function 48 is larger and equal to 1 s, the port synchronization adjuster function 49 may update Port State Machine to UNLOCK state and apply the Offset_{NW-TT} to the NW-TT port's time clock to adjust the time of the port, as shown in steps 1 and 2 of FIG. 10.

When Offset_{NW-TT} is less than 1 second, at step 97, the port synchronization adjuster function 49 may determine if Port State is LOCK. If so (indicating port synchronization has reached preliminary stability), the port synchronization adjuster function 49 may deliver Offset_{NW-TT} to the clock frequency adjuster function 46 for finer clock frequency adjustments, as shown in step 3 of FIG. 10.

If it is determined, at step 97, that the Port State is UNLOCK, then the port synchronization adjuster function 49 may set Port State to LOCK and wait for Offset_{NW-TT} becoming stable at next synchronization time, as shown in step 4 of FIG. 10. Note that, the steps 96 and 97 are optional, the Offset_{NW-TT} may be sent to the clock frequency adjuster function 46 directly.

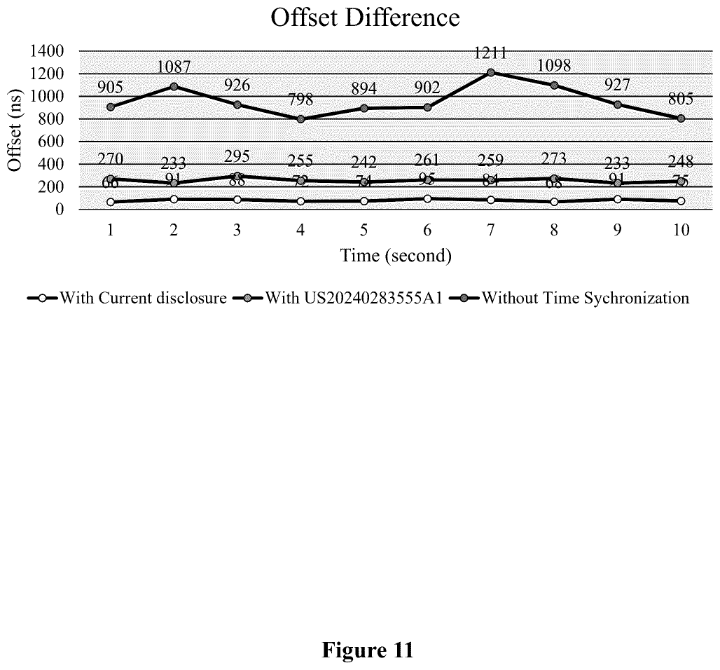

FIG. 11 is a chart showing the advantage of the embodiments of the disclosure. The following table are data calculated from the FIG. 11.

| | Current | | Without Time |
|---|---|---|---|
| Metric(ns) | Patent | US20240283555A1 | Synchronization |
| Mean | 80.4 | 256.9 | 955.3 |
| Standard Deviation | 10.6 | 19.3 | 136.2 |
| Data Range | 66-95 | 233-295 | 798-1211 |

As may be seen, without time synchronization enhancement, time synchronization relies on original clock time offset between NW-TT port and N3 port which is read by software. With current disclosure, offsets become smoother and is significantly reduced (about 91%) compared with the case without time synchronization. With current disclosure, offsets are reduced (about 68%) compared with the parent application US20240283555A1. With current disclosure, offsets decrease significantly to constrain within double digits in nanosecond, and more stable implying the 5G GM and NW-TT clocks achieve higher-precision synchronization.

The disclosure also provides a non-transitory computer-readable medium storing machine-readable instructions, wherein, when the machine-readable instructions are executed by a processor, they configure the processor to implement the method of any one of the appended method claims.

The apparatus described above may be implemented at least in part in software. Those skilled in the art will appreciate that the apparatus described above may be implemented at least in part using general purpose computer equipment or using bespoke equipment.

Here, aspects of the methods and apparatuses described herein can be executed on any apparatus comprising the communication system. Program aspects of the technology can be thought of as “products” or “articles of manufacture” typically in the form of executable code and/or associated data that is carried on or embodied in a type of machine-readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible non-transitory “storage” media, terms such as computer or machine “readable medium” refer to any medium that participates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

What is claimed is:

1. A method of synchronizing a Network-Side Time-Sensitive Networking (TSN) Translator (NW-TT) module inside a User Plane Function (UPF) of a communication network with a Grandmaster (GM) in a Time Domain of the communication network, the method comprising the steps of:
receiving one or more Precision Time Protocol (PTP) or Generalized Precision Time Protocol (gPTP) messages on an N3 interface of the UPF;
determining a first time offset value (Offset_{N3}) between the GM and the N3 interface based on information received in the one or more PTP or gPTP messages;
adjusting a time or a clock frequency of the N3 interface using the determined first time offset value (Offset_{N3}) to synchronize the time between the N3 interface and the GM;
generating one or more pulses at a pin of the N3 interface;
detecting the one or more pulses at a pin of the NW-TT module;
determining a second time offset value (Offset_{NW-TT}) between the N3 interface and the NW-TT module according to a time of generating one pulse of the one or more pulses (T′_{N3}) and a time of detecting the pulse (T_{NW-TT}); and
adjusting a time or a clock frequency of the NW-TT module using the determined second time offset value (Offset_{NW-TT}) to synchronize the time between the NW-TT module and the GM.

2. The method of claim 1, wherein the Time Domain of the communication network is a 5G Time Domain, and the one or more PTP or gPTP messages received by the N3 interface contain synchronization information in peer-to-peer mode or end-to-end mode and the method comprises the steps of:
storing a first time T₁ relating to sending a PTP or gPTP Pdelay_Req message;
extracting a second time T₂ from a PTP or gPTP Pdelay_Resp message;
extracting a third time T₃ from a PTP or gPTP Pdelay_Resp_Follow_Up message;
storing a fourth time T₄ relating to receiving a PTP or gPTP Pdelay_Resp message; and
determining an N3 interface delay (Delay_{N3}) from the formula:
$${Delay}_{N 3} = [ ( {T}_{2} - {T}_{1} ) + ( {T}_{4} - {T}_{3} ) ] / 2.$$

3. The method of claim 2, comprising the steps of:
extracting a fifth time T₅ and a Correction Field (CF) elapsed time value from a PTP or gPTP Follow_Up message;
storing a sixth time T₆ relating to receiving a PTP or gPTP Sync message; and
determining the first time offset value (Offset_{N3}) between the GM and the N3 interface from the formula:
$${Offset}_{N 3} = ( {T}_{6} - {T}_{5} ) - {Delay}_{N 3} - CF elapsed time value .$$

4. The method of claim 1, wherein the pin of the N3 interface is a General-Purpose Input/Output (GPIO) pin of the N3 interface, and the pin of the NW-TT module is a GPIO pin of the NW-TT module, and wherein the GPIO pin of the N3 interface and the GPIO pin of the NW-TT module are physically interconnected, to detect the one or more pulses.

5. The method of claim 4, wherein the one or more pulses are one or more Pulse Per Second (PPS) signals, and
wherein the GPIO pin of the N3 interface is configured to generate the one or more PPS signals with a pulse width of 110 milliseconds (ms).

6. The method of claim 5, wherein the GPIO pin of the NW-TT module is configured to detect the one or more PPS signals during a wake-up period of a 100 ms cycle, and
wherein the GPIO pin of the NW-TT module is configured to capture an interface clock time upon detecting high-level of the one or more PPS signals, so as to implement a multi-port synchronization.

7. The method of claim 1, further comprising:
setting a periodic timer with a 100 ms cycle, for detecting the one or more pulses and determining the second time offset value (Offset_{NW-TT}).

8. The method of claim 7, wherein upon wake-up of the timer, a trigger time (T′_{N3}) for the GPIO pin of the N3 interface is updated to the next full-second value when a current N3 clock time (T_{N3}) of the N3 interface exceeds the trigger time (T′_{N3}), according to the formula:
$${T}_{N 3}^{′} = ⌊ {T}_{N 3} ⌋ + 1 , if {T}_{N 3} > {T}_{N 3}^{′} ,$$
to generate a pulse at the next full-second value.

9. The method of claim 8, wherein upon detecting a high-level signal at the pin of the NW-TT module, a corresponding timestamp (T_{NW-TT}) is captured as the time of detecting the pulse (T_{NW-TT}), and
wherein the second time offset value (Offset_{NW-TT}) is determined as:
$${Offset}_{NW - TT} = {T}_{NW - TT} - {T}_{N 3}^{′} .$$

10. The method of claim 5, further comprising:
dynamically reconfiguring the pulse width of the PPS signal based on one or more network latency measurements,
wherein the pulse width is adjustable within a range of 100 ms to 200 ms to accommodate varying detection capabilities of the NW-TT module.

11. The method of claim 1, further comprising:
maintaining a port state machine with states including a UNLOCK state and a LOCK state for maintaining stability of a multi-port synchronization.

12. The method of claim 11, wherein the clock frequency of the NW-TT module is adjusted, when the second time offset value (Offset_{NW-TT}) is less than 1 second and the port state machine is in a LOCK state.

13. The method of claim 11, wherein the port state machine is set to a LOCK state without adjusting the time or clock frequency of the NW-TT module, to wait for the second time offset value (Offset_{NW-TT}) stabilization at a next synchronization interval, when the second time offset value (Offset_{NW-TT}) is less than 1 second and the port state machine is in a UNLOCK state.

14. The method of claim 11, wherein the time of the NW-TT module is adjusted and the port state machine is set to a UNLOCK state, when the second time offset value (Offset_{NW-TT}) is greater than or equal to 1 second.

15. A Data Plane Clock Servo module in a User Plane Function (UPF) module for synchronizing a Network-Side Time-Sensitive Networking (TSN) Translator (NW-TT) module inside the UPF of a communication network with a Grandmaster (GM) in a Time Domain of the communication network, the Data Plane Clock Servo module comprising:
a protocol module, configured to receive one or more Precision Time Protocol (PTP) or Generalized Precision Time Protocol (gPTP) messages on an N3 interface of the UPF; and determine a first time offset value (Offset_{N3}) between the GM and the N3 interface based on information received in the one or more PTP or gPTP messages;
a pulse handler module, configured to generate one or more pulses at a pin of the N3 interface; detect the one or more pulses at a pin of the NW-TT module; and determine a second time offset value (Offset_{NW-TT}) between the N3 interface and the NW-TT module according to a time of generating one pulse of the one or more pulses (T′_{N3}) and a time of detecting the pulse (T_{NW-TT});
a synchronization adjuster module, configured to adjust a time of the N3 interface using the determined first time offset value (Offset_{N3}) or adjust a time of the NW-TT module using the determined second time offset value (Offset_{NW-TT}); and
a clock frequency adjuster module, configured to adjust a clock frequency of the N3 interface using the determined first time offset value (Offset_{N3}) or adjust a clock frequency of the NW-TT module using the determined second time offset value (Offset_{NW-TT}).

16. The Data Plane Clock Servo module of claim 15, wherein the pulse handler module is further configured to set a periodic timer with a 100 ms cycle, for detecting one or more PPS signal and determining the second time offset value (Offset_{NW-TT});
wherein the pulse handler module is further configured to dynamically reconfigure the pulse width of the PPS signal based on one or more network latency measurements, and
wherein the pulse width is adjustable within a range of 100 ms to 200 ms to accommodate varying detection capabilities of the NW-TT module.

17. The Data Plane Clock Servo module of claim 16, wherein the pulse handler module is further configured to: upon wake-up of the timer, update a trigger time (T′_{N3}) for the GPIO pin of the N3 interface to the next full-second value when a current N3 clock time (T_{N3}) of the N3 interface exceeds the trigger time (T′_{N3}), according to the formula:
$${T}_{N 3}^{′} = ⌊ {T}_{N 3} ⌋ + 1 , if {T}_{N 3} > {T}_{N 3}^{′} ,$$
to generate a pulse at the next full-second value.

18. The Data Plane Clock Servo module of claim 17, wherein upon detecting a high-level signal at the pin of the NW-TT module, a corresponding timestamp (T_{NW-TT}) is captured as the time of detecting the pulse (T_{NW-TT}), and
wherein the second time offset value (Offset_{NW-TT}) is determined as:
$${Offset}_{NW - TT} = {T}_{NW - TT} - {T}_{N 3}^{′} .$$

19. The Data Plane Clock Servo module of claim 15, wherein the synchronization adjuster module is configured to:
maintain a port state machine with states including a UNLOCK state and a LOCK state;
transfer the second time offset value (Offset_{NW-TT}) to the clock frequency adjuster module, when the second time offset value (Offset_{NW-TT}) is less than 1 second and the port state machine is in a LOCK state;
set the port state machine to a LOCK state, to wait for the second time offset value (Offset_{NW-TT}) stabilization at a next synchronization interval, when the second time offset value (Offset_{NW-TT}) is less than 1 second and the port state machine is in a UNLOCK state; and
adjust the time of the NW-TT module and set the port state machine to a UNLOCK state, when the second time offset value (Offset_{NW-TT}) is greater than or equal to 1 second.

20. A non-transitory computer-readable medium storing machine-readable instructions, wherein, when the machine-readable instructions are executed by a processor, the instructions configure the processor to:
receiving one or more Precision Time Protocol (PTP) or Generalized Precision Time Protocol (gPTP) messages on an N3 interface of a User Plane Function (UPF);
determining a first time offset value (Offset_{N3}) between a GM of a communication network and the N3 interface based on information received in the one or more PTP or gPTP messages;
adjusting a time or a clock frequency of the N3 interface using the determined first time offset value (Offset_{N3}) to synchronize the time between the N3 interface and the GM;
generating one or more pulses at a pin of the N3 interface;
detecting the one or more pulses at a pin of a Network-Side Time-Sensitive Networking (TSN) Translator (NW-TT) module inside the UPF;
determining a second time offset value (Offset_{NW-TT}) between the N3 interface and the NW-TT module according to a time of generating one pulse of the one or more pulses (T′_{N3}) and a time of detecting the pulse (T_{NW-TT}); and
adjusting a time or a clock frequency of the NW-TT module using the determined second time offset value (Offset_{NW-TT}) to synchronize the time between the NW-TT module and the GM.
